(19) United States
(12) Patent Application Publication
(10) Pub. No.: US 2004/0266926 A1
(43) Pub. Date: Dec. 30, 2004

(54) Resin powder for cosmetic and cosmetic using the same

(75) Inventors: Yuki Sasaki, Kanagawa (JP); Hirotaka Matsuoka, Kanagawa (JP)

Correspondence Address: OLIFF & BERRIDGE, P.O. BOX 19928, ALEXANDRIA, VA, 22320, US

(73) Assignee: FUJI XEROX CO., LTD., Tokyo (JP)

(21) Appl. No.: 10/731,031

(22) Filed: Dec. 10, 2003

(30) Foreign Application Priority Data
Jun. 27, 2003 (JP) P.2003-185632

(51) Int. Cl. C08J 3/00

(52) U.S. Cl. 524/275

(57) ABSTRACT

The resin powder for cosmetic of the invention is a resin powder for cosmetic constituted of an agglomerate of resin-containing particles, wherein the resin-containing particles have a degree of hydrophobicity of the resin-containing particles is from 10% to 60% and an average value of shape factors SF1 defined by the following equation: SF1=(ML²/A)×(π/4)×100 (wherein ML represents a maximum length of the resin-containing particles, and A represents a projected area of the resin-containing particles) of from 110 to 140; and wherein when seen from the direction in which the projected area of the resin-containing particles to the plane becomes maximum, the major axis a, the minor axis b, and the thickness c are simultaneously satisfactory with the following equations: 0.5<b/a<1 and 0.4<c/b<0.8.

### BACKGROUND OF THE INVENTION

1. Field of the Invention

The present invention relates to a resin powder for cosmetic, which is used in cosmetics, and to a cosmetic using the same.

2. Description of the Related Art

Hitherto, cosmetics such as foundations, eye shadows, baby powders, emulsions, antiperspirant powders, and body shampoos usually contain a resin powder. Physicochemical characteristics of resin-containing particles constituting such a resin powder, such as shape, particle size distribution, surface state, hardness, glass transition point, and mean molecular weight, and monomers constituting the resin-containing particles and weight ratios thereof largely dominate spreadability mainly upon application and usability such as proper affinity to the skin after application. Accordingly, for the purpose of improving these characteristics, various improvements about resin powders have been conducted.

For example, in JP-A-2000-302828, plate-like organic silicone resin powders that design to not only improve texture, spreadability and touch in cosmetics but also solve a feeling of wrongness such as hard feeling or stickiness of cosmetics are disclosed.

### SUMMARY OF THE INVENTION

However, cosmetics containing the conventional plate-like organic silicone resin powder described in JP-A-2000-302828. is accompanied with the following problems.

That is, in the foregoing cosmetics, the plate-like organic silicone resin powder is not sufficiently compatible with oil components generally contained in cosmetics so that the organic silicone resin powders coagulate each other. For that reason, when such a cosmetic is applied to the skin, spreadability of the cosmetic became insufficient. Affinity of the cosmetic after application to the skin was not sufficient.

Under such background, the invention has been made. An object of the invention is to provide a resin powder for cosmetic capable of making a cosmetic improve spreadability upon application to the skin and affinity after application and a cosmetic using the same.

For the sake of solving the foregoing problems, the present inventors made extensive and intensive investigations. As a result, it has been found that the foregoing problems can be solved by setting up each of a degree of hydrophobicity and a shape factor SF1 of the resin powder to a specific range and making the resin powder have a specific shape, leading to accomplishment of the invention.

Specifically, the resin powder for cosmetic of the invention is a resin powder for cosmetic constituted of an agglomerate of particles containing a resin, wherein the particles have a degree of hydrophobicity of from 10% to 60% and an average value of shape factors SF1 defined by the following equation:

SF1=(ML²/A)×(π/4)×100 (1)

(wherein ML represents a maximum length of the particles, and A represents a projected area of the particles) of from 110 to 140; and wherein when seen from the direction in which the projected area of the particles to the plane becomes maximum, the major axis a, the minor axis b, and the thickness c are simultaneously satisfactory with the following equations:

0.5<b/a<1 (2)

0.4<c/b<0.8 (3)

According to this resin powder for cosmetic, it is possible to impart more sufficient spreadability and adhesiveness to cosmetics as compared to the case where the degree of hydrophobicity, shape factor SF1, and b/a or c/b fall outside the foregoing ranges. That is, when the resin powder for cosmetic of the invention falls within the foregoing range with respect to the degree of hydrophobicity, in the case where it is compounded in a cosmetic, it becomes compatible with oil components generally contained in the cosmetic so that dispersibility of the resin powder for cosmetic in the cosmetic is improved. When the shape factor SF1 of the particles and b/a or c/b as parameters defining-the shape fall within the foregoing ranges, reduction in smoothness of the particles is sufficiently prevented, and at the same time, adhesion of the resin-containing particles to the skin is sufficiently improved. For that reason, when the resin powder for cosmetic of the invention is compounded in a cosmetic, and the cosmetic is applied to the skin, more sufficient spreadability is revealed as compared with the case where the degree of hydrophobicity, shape factor SF1, and b/a or c/b fall outside the foregoing ranges. And after application, it is possible to impart more proper affinity to the skin as compared with the case where the degree of hydrophobicity, shape factor SF1, and b/a or c/b fall outside the foregoing ranges.

The cosmetic of the invention is characterized in that in a cosmetic containing a resin powder and oil components, the resin powder is the foregoing resin powder for cosmetic.

According to this cosmetic, when the particles containing a resin have a degree of hydrophobicity of from 10% to 60%, the oil components and the resin powder for cosmetic to be contained in the cosmetic are compatible with each other so that the resin powder for cosmetic is in the state where it is thoroughly dispersed in the cosmetic. For that reason, according to the cosmetic of the invention, more sufficient spreadability is revealed upon application to the skin as compared with the case where the degree of hydrophobicity, shape factor-SF1, and b/a or c/b fall outside the foregoing ranges. And after application, it is possible to impart more proper affinity to the skin as compared with the case where the degree of hydrophobicity, shape factor SF1, and b/a or c/b fall outside the foregoing ranges.

### BRIEF DESCRIPTION OF THE DRAWING

FIG. 1 is a plan view schematically showing a projected image of the resin-containing particle constituting the resin powder of the invention to the plane.

FIG. 2 is a plan view schematically showing a projected image of the resin-containing particle to the plane when rotated around a line segment AB of FIG. 1 as an axis.

### DETAILED DESCRIPTION OF THE PREFERRED EMBODIMENTS

Embodiments of the invention will be hereunder described in detail.

[Resin Powder for Cosmetic]

First of all, the resin powder for cosmetic (hereinafter referred to as “resin powder”) of the invention will be described.

The resin powder of the invention is constituted of an agglomerate of resin-containing particles, wherein the resin-containing particles have a degree of hydrophobicity of from 10% to 60% and an-average value of shape factors SF1 defined by the following equation:

SF1=(ML²/A)×(π/4)×100 (1)

(wherein ML represents a maximum length of the resin-containing particles, and A represents a projected area of the resin-containing particles) of from 110 to 140; and wherein when seen from the direction in which the projected area of the resin-containing particles to the plane becomes maximum, the major axis a, the minor axis b, and the thickness c are simultaneously satisfactory with the following equations:

0.5<b/a<1 (2)

0.4<c/b<0.8 (3)

According to this resin powder, it is possible to impart more sufficient spreadability and adhesion to cosmetics as compared to the case where the degree of hydrophobicity, shape factor SF1, and b/a or c/b fall outside the foregoing ranges. That is, when the resin powder for cosmetic of the invention falls within the foregoing range with respect to the degree of hydrophobicity, in the case where it is compounded in a cosmetic, it becomes compatible with oil components generally contained in the cosmetic so that dispersiblity of the resin powder for cosmetic in the cosmetic is improved. When the shape factor SF1 of the resin-containing particles and b/a or c/b as parameters defining the shape fall within the foregoing ranges, reduction in smoothness of the resin-containing particles is sufficiently prevented, and at the same time, adhesion of the resin-containing particles to the skin is sufficiently improved. For that reason, when the resin powder of the invention is compounded in a cosmetic, and the cosmetic is applied to the skin, more sufficient spreadability is revealed as compared with the case where the degree of hydrophobicity, shape factor SF1, and b/a or c/b fall outside the foregoing ranges. And after application, it is possible to impart more proper affinity to the skin as compared with the case where the degree of hydrophobicity, shape factor SF1, and b/a or c/b fall outside the foregoing ranges.

In the resin powder of the invention, the degree of hydrophobicity of the resin-containing particles means a value calculated based on the following equation:

[Degree of hydrophobicity (%)]=[(methanol concentration 1(%))+(methanol concentration 2(%))]/2

In the equation, the methanol concentration 1 means a concentration of methanol (unit: % by volume) in a methanol aqueous solution when in the case where the resin powder is added to the methanol aqueous solution, a part of the resin powder causes sedimentation and suspension. The methanol concentration 2 means a minimum concentration (unit: % by volume) in a methanol aqueous solution when in the case where the resin powder is added to the methanol aqueous solution, the resin powder causes suspension without floating on the liquid level. In the state that the methanol aqueous solution does not suspend, when the resin-containing particles float on the liquid level and start to cause suspension, a part of the resin-containing particles starts to sink under water, and when all of the resin-containing particles suspend, they completely sink under water so that the system becomes clouded.

The foregoing methanol concentrations 1 and 2 can be determined according to the following manner. That is, first of all, a plural number of beakers are prepared. Sixty mL of plural methanol aqueous solutions having a concentration different from each other by 10% from 0 to 100% are respectively charged in each of these beakers. Then, 0.1 g of the resin powder is added to each aqueous solution, the mixture is lightly stirred by a magnet stirrer, and the aqueous solution in the beaker is observed. From the observation results, the methanol concentration 1 and methanol concentration 2 are determined. Examples of the measurement of the methanol—concentration and the observation results are shown in Table 1. In Table 1, ◯, Δ and × are those described according to the following criteria.

TABLE 1

| Methanol | | | |
|---|---|---|---|
| concentration | Methanol | Water | Observation |
| (%) | (mL) | (mL) | results |
| 0 | 0 | 60 | ◯ |
| 10 | 6 | 54 | ◯ |
| 20 | 12 | 48 | Δ |
| 30 | 18 | 42 | X |
| 40 | 24 | 36 | X |
| 50 | 30 | 30 | X |
| 60 | 36 | 24 | X |
| 70 | 42 | 18 | X |
| 80 | 48 | 12 | X |
| 90 | 54 | 6 | X |
| 100 | 60 | 0 | X |

◯: All of the resin-containing particles float.
Δ: The resin-containing particles partly suspend.
X: All of the resin-containing particles suspend.

It is understood from the results shown in Table 1 that the methanol concentration 1 is 20%, the methanol concentration 2 is 30%, and the degree of hydrophobicity is 25%.

When the degree of hydrophobicity of the resin-containing particles is less than 10%, in the case where the resin-containing particles are compounded in a cosmetic and applied to the skin, spreadability of the cosmetic and affinity after application becomes insufficient. On the other hand, when the degree of hydrophobicity of the resin-containing particles exceeds 60%, compatibility with the oil components becomes worse to cause coagulation of the particles, whereby fine texture after application is lost. The degree of hydrophobicity of the resin-containing particles is preferably from 20% to 50%, and more preferably from 25% to 40%. In the case where the degree of hydrophobicity falls within the foregoing range, when the resin powder is compounded in a cosmetic and applied to the skin, spreadability is especially sufficiently revealed, and after application, more proper affinity to the skin is imparted by the cosmetic.

With respect to the shape factor SF1, in the foregoing equation (1), the projected area of the resin-containing particles means an area of the resin-containing particle image projected on the plane when light is projected to the resin-containing particles opposing to the plane from the resin-containing particle side along the optical axis perpendicular to that plane. When this shape factor SF1 is close to 100, the resin-containing particles become close to a true sphere. On the other hand, when it is too large, irregularities are generated on the surface, and the shape of the resin-containing particles becomes far from a true sphere.

When the shape factor SF1 defined by the foregoing equation (1) is less than 110, the shape of the resin-containing particles becomes close to a true sphere, and in cosmetics, spreadability upon application can be sufficiently revealed. However, it becomes impossible to impart proper adhesion or affinity that is considered necessary after application of a cosmetic. On the other hand, when the shape factor SF1 exceeds 140, since irregularities are generated on the surfaces of the resin-containing particles, though adhesion to the skin is improved, spreadability upon application becomes insufficient.

The shape factor SF1 is calculated by mainly analyzing a microscopic image or a scanning electron microscopic image by an image analyzer (LUZEX III manufactured by Nireco Corporation), measuring the maximum length ML and projected area A of the resin-containing particles, and substituting them in the foregoing equation.

The upper limit of the shape factor SF1 is preferably 130, and more preferably 120. In the case where the shape factor SF1 is not more than 130, the shape of the resin-containing particles becomes close to a true sphere so that fluidity on the skin surface is improved, and when compounded in a makeup cosmetic, etc., smoothness upon application is further improved so that uniform application on the skin becomes possible.

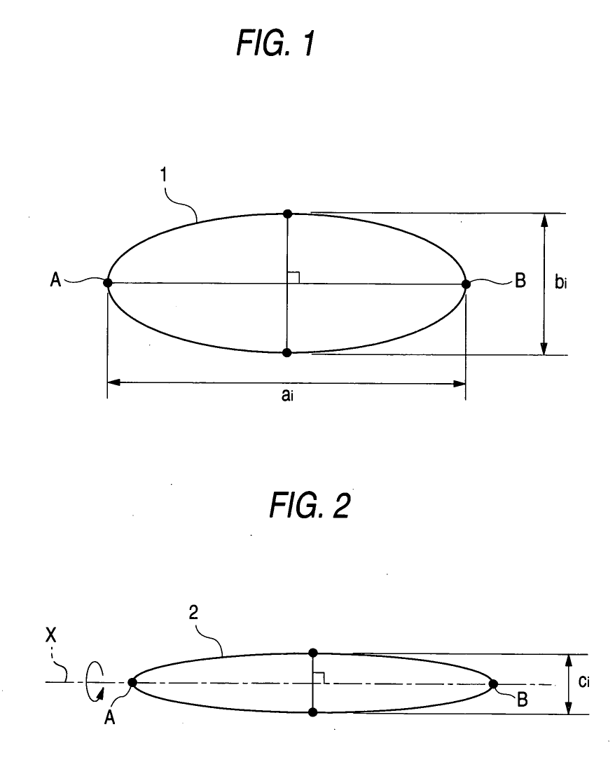

The shape of the resin-containing particles is a flat sphere. That is, the shape of the resin-containing particles is not a so-called cigar shape or an acicular or tabular form, but a disk-like shape or an elliptical shape keeping a sphere to some extent, such as a rugby ball shape. Such a shape can be generally regulated according to the foregoing equations (2) and (3). The direction where the projected area of the resin-containing resins constituting the resin particles of the invention to the plane becomes maximum can be determined by selecting arbitrary resin-containing particles using an electron microscope and rotating an observation stage on which the resin-containing particles are placed in various directions to seek the direction where the projected area becomes maximum. Major axis a is an average value of a major axis aᵢ (i represents an integer of from 1 to 50) with respect to each of arbitrarily extracted fifty resin-containing particles. The major axis aᵢ means a length of the longest line segment of line segments AB passing through two points A and B on the edge of a projected image 1 to the plane as shown in FIG. 1. The minor axis b is an average value of a minor axis bᵢ (i represents an integer of from 1 to 50) with respect to each of arbitrarily extracted fifty resin-containing particles. The minor axis bᵢ means a length of the longest line segment of line segments rectangular to the line segment AB expressing the major axis aᵢ. The thickness c is an average value of a thickness cᵢ (i represents an integer of from 1 to 50) with respect to each of arbitrarily extracted fifty resin-containing particles. The thickness cᵢ means a length of the line segment when after measuring the major axis aᵢ and the minor axis bᵢ, the plane on which the resin-containing particles are placed is rotated at 60° to 120° around the line segment expressing the major axis aᵢ or the minor axis bᵢ as an axis, and the length of the longest line segment of line segments perpendicular to the rotating axis X in a projected image 2 of the resin-containing particles to the plane becomes minimum (see FIG. 2). The foregoing major axis aᵢ, minor axis bᵢ and thickness cᵢ are values when the resin-containing particles are observed under the following condition using a field emission-scanning electrode microscope (FE-SEM) (Model S-2700, a trade name of Hitachi, Ltd.).

Accelerating voltage: 20 kV

Magnification: 5,000 times

The foregoing major axis aᵢ, minor axis bᵢ and thickness cᵢ can be usually determined by image analysis utilizing FE-SEM.

When b/a or c/b falls outside the range of the equation (2) or (3), the resin-containing particles lose smoothness, and when a cosmetic having the resin powder compounded therein is applied to the skin, its spreadability becomes extremely worse. It is preferable that b/a is from 0.65 to 0.85. When b/a falls within this range, when a cosmetic having the resin powder compounded therein is applied to the skin, its spreadability is further improved as compared with the case where b/a falls outside the foregoing range. It is preferable that c/b is from 0.33 to 0.67. When c/b falls within this range, when a cosmetic having the resin powder compounded therein is applied to the skin, its spreadability is further improved as compared with the case where c/b falls outside the foregoing range.

a is usually from 2 to 20 μm, b is usually from 1 to 10 μm, and c is usually from 0.2 to 8 μm, respectively.

In the resin powder of the invention, it is preferable that the agglomerate of the resin-containing particles has an average volume particle size of from 2 to 20 μm.

In this case, not only use feeling of a cosmetic upon application (for example, uniformity in application thickness of the cosmetic caused by uneven application) is excellent, but also a hiding power of the cosmetic on the skin is improved. In contrast, in the case where the average volume particle size exceeds 20 μm, foreign body sensation appears upon application of the cosmetic so that use feeling (for example, uniformity in application thickness of the cosmetic caused by uneven application) is lowered and that rough surface becomes remarkable. Excessive irritation may possibly be given to the skin. Further, it tends to become difficult to control characteristics possessed by the resin-containing particles. On the other hand, when the average volume particle size is less than 2.0 μm, the proportion of the small-sized resin-containing particles increases. For that reason, in the case where the resin powder is compounded in a cosmetic and applied to the skin, the resin-containing particles enter wrinkles of the skin, and bias in distribution of the resin-containing particles is generated so that a hiding power of the cosmetic on the skin may possibly be lowered.

It is more preferable from the viewpoints of not only more improving the use feeling but also more sufficiently preventing a reduction in hiding powder of a cosmetic having the resin-containing particles compounded therein upon application to the skin that the average volume particle size is from 3.0 to 15.0 μm.

It is preferable that the resin to be contained in the resin-containing particles that are used in the invention has a glass transition temperature Tg of from 10 to 100° C. The term “glass transition temperature” as referred to herein means a glass transition temperature measured at a temperature rising rate of 10° C./min using a differential scanning calorimeter (DSC-50 manufactured by Shimadzu Corporation). When the glass transition temperature of the resin is lower than 10° C., in the case where the resin-containing particles are compounded in a cosmetic and applied to the skin, it tends to become difficult to impart dry touch to the cosmetic after application. On the other hand, when it exceeds 100° C., it tends to become impossible to thoroughly endure proper affinity of the cosmetic to the skin.

The glass transition temperature of the resin to be contained in the resin-containing particles is more preferably from 30 to 80° C. from the viewpoints of enhancing dry touch of the cosmetic after application and thoroughly enduring proper affinity.

It is preferable that the resin powder of the invention has a surfaceness index defined by the following equations of not more than 2.0.

(Surfaceness index)=(specific surface area measured)/(specific surface area calculated) (4)

(Specific surface area calculated)=6Σ(n×R²)/{ρ×Σ(n×R³)} (5)

In the equation (5), n represents the number of particles within a channel of a particle size distribution measurement device; R represents a diameter (μm) of the channel of the particle size distribution measurement device; and ρ represents a density (g/cm³) of the agglomerate of the resin-containing particles. Here, Coulter counter (TAII manufactured by Nikkaki Bios Co., Ltd.) is employed as a particle size distribution measurement device.

The number of channels in the Coulter counter is 16, the particle size range of from 1.26 μm to 50.8 μm is divided into 16 sections at an interval of 0.1 in terms of log scale, and the divided respective particle size range is assigned to each channel. For example, the number of particles in the particle size range of 1.26 μm or more and less than 1.59 μm is counted by channel 1; the number of particles in the particle size range of 1.59 μm or more and less than 2.00 μm is counted by channel 2; and the number of particles in the particle size range of 2.00 μm or more and less than 2.52 μm is counted by channel 3. Incidentally, log 1.26=0.1, log 1.59=0.2, log 2.00=0.3, . . . , log 50.8=1.6. For example, with respect to the channel 1, the particle size range of 1.26 μm or more and less than 1.59 μm is an interval of 0.1 in terms of log scale. With respect to other channels, each particle size range is similarly an interval of 0.1 in terms of log scale.

Here, the surfaceness index is an index of the surface state of the resin-containing particles. As the surfaceness index is close to 1.0, the surface of the resin-containing particles becomes smoother. On the other hand, as the surfaceness index is far from 1.0, the surface becomes rougher.

When the surfaceness index of the resin powder is not larger than 2.0, use feeling such as affinity is more improved as compared with the case where the number average molecular weight Mn of the resin and the surfaceness index fall outside the foregoing ranges.

The resin to be contained in the resin-containing particles usually has a number average molecular weight Mn of from 5,000 to 1,000,000. The term “number average molecular weight” as referred to herein means a number average molecular weight measured using a molecular weight analyzer (HLC-8120 manufactured by Tosoh Corporation). When the number average molecular weight is less than 5,000, in the case where the resin powder is compounded in a cosmetic, the resin-containing particles likely cause coagulation, and the cosmetic becomes soft so that usability and preservability are liable to be interfered. On the other hand, when it exceeds 1,000,000, the resin-containing particles become too hard so that usability and preservability are liable to be interfered (specifically, in the case where the resin powder is compounded in a cosmetic and applied to the skin, affinity of the cosmetic to the skin is reduced, and the tautness is generated after application of the cosmetic).

The number average molecular weight Mn of the resin is preferably from 5,000 to 20,000 from the viewpoint of further improving usability, preservability, and the like.

The resin constituting the resin-containing particles to be used in the resin powder of the invention is not particularly limited so far as its degree of hydrophobicity falls within the foregoing range. Concretely, the resin is mainly constituted of a homopolymer of one kind of a monomer of the following component (A), a copolymer of two or more kinds of monomers constituting the following component (A), or a mixture of such homopolymer and copolymer.

Examples of the component (A) include styrene and derivatives thereof, acrylic acid esters, methacrylic acid esters, ethylenically unsaturated acid monomers, vinylnitriles, vinyl ethers, vinyl ketones, and olefins. Examples of styrene derivatives include p-chlorostyrene and α-methylstyrene; examples of acrylic acid esters include methyl acrylate, ethyl acrylate, n-butyl acrylate, lauryl acrylate, and 2-ethylhexyl acrylate; and examples of methacrylic acid esters include methyl methacrylate, ethyl methacrylate, n-propyl methacrylate, lauryl methacrylate, and 2-ethylhexyl methacrylate. Examples of ethylenically unsaturated acid monomers include acrylic acid, methacrylic acid, and sodium styrenesulfonate; examples of vinylnitriles include acrylonitrile and methacrylonitrile; examples of vinyl ethers include vinyl methyl ether and vinyl isobutyl ether; examples of vinyl ketones include vinyl methyl ketone, vinyl ethyl ketone, and vinyl isopropenyl ketone; and examples of olefins include ethylene, propylene, and butadiene. Of these resins, as the resin to be compounded for the sake of imparting characteristics as a cosmetic, styrene based copolymers are preferable from the standpoint of controllability of the foregoing molecular weight, Tg and surfaceness index, etc., and styrene-acrylate copolymers are more preferable from the standpoint of easiness in controlling the degree of hydrophobicity to an optimum value.

The resin may further contain epoxy resins, polyester resins, polyurethane resins, polyamide resins, cellulose resins, polyether resins, or non-vinyl condensation type resins. Alternatively, the resin-containing particles may be a mixture of such a resin as epoxy resins and a homopolymer of the component (A) or a vinyl based resin among the copolymers of two or more kinds of monomers of the component (A), or a graft polymer obtained by polymerizing a vinyl based monomer in the co-presence of these resins.

The resin-containing particles that are used in the invention may have a crosslinking structure. The resin-containing particles having such a crosslinking structure can be obtained by crosslinking reaction of resins in the presence of a crosslinking agent. Here, the addition amount of the crosslinking agent is from 0.01 to 5 parts by weight, and preferably from 0.1 to 2 parts by weight based on 100 parts by weight of the resins. When the addition amount of the crosslinking agent is less than 0.01 parts by weight, the shape of the resin-containing particles becomes likely instable, and when compounded in a cosmetic, coagulation of the resin-containing particles likely occurs in the cosmetic, stickiness of the cosmetic likely increases, and refreshing feeling of the cosmetic is liable to lose. On the other hand, when it exceeds 5 parts by weight, softness of the resin-containing particles is likely lowered so that the touch of the cosmetic becomes likely worse and that the tautness likely increases.

The crosslinking agent may be properly selected in relation with the resin. Specifically, boron compounds are preferable from the standpoint of rapidness of the crosslinking reaction. Examples of boron compounds include borax, boric acid, boric acid salts (such as orthoborates (such as InBO₃, ScBO₃, YBO₃, LaBO₃, Mg₃(BO₃)₂, and Co₃(BO₃)₂), biborates (such as Mg₂B₂O₅ and CO₂B₂O₃), metaborates (such as LiBO₂, Ca(BO₂)₂, NaBO₂, and KBO₂), tetraborates (such as Na₂B₄O₇.10H₂O), and pentaborates (such as KB₅O₈.4H₂O, Ca₂B₆O₁₁.7H₂O, and CsB₅O₅). Other examples of the crosslinking agent include aldehyde based compounds such as formaldehyde, glyoxal, melamine.formaldehydes (such as methylolmelamine and alkylated methylolmelamines), and glutaldehyde; ketone based compounds such as diacetyl and cyclopentanedione; active halogen compounds such as bis-(2-chloroethylurea)-2-hydroxy-4,6-dichloro-1,3,5-triazine and 2,4-dichloro-6-S-triazine.sodium salt; active vinyl compounds such as divinylsulfonic acid, 1,3-vinyl-sulfonyl-2-propanol, N,N′-ethylenebis(vinylsulfonylacet-amide), and 1,3,5-triacryloyl-hexahydro-S-triazine; N-methylol compound such as dimethylolurea and methylol-dimethyl hydantoin; resol resins; isocyanate based compounds such as polyisocyanate and 1,6-hexamethylene diisocyanate; aziridine based compounds described in U.S. Pat. Nos. 3,017,280 and 2,983,611; carboxyimide based compounds described in U.S. Pat. No. 3,100,704; epoxy based compounds such as epoxy resins and glycerol triglycidyl ether; ethyleneimino based compounds such as 1,6-hexamethyl-ene-N,N′-bisethyleneurea; halogenated carboxyaldehyde based compounds such as mucochloric acid and mucophenoxychloric acid; dioxane based compounds such as 2,3-dihydroxydioxane; chromium alum; potassium alum; zirconium sulfate; and chromium acetate. These crosslinking agents may be used singly or in admixture of two or more thereof.

In the case where the resins are subjected to crosslinking reaction in the presence of a crosslinking agent, the crosslinking agent is usually used as a crosslinking agent solution containing the crosslinking agent. The crosslinking agent solution is prepared by dissolving a crosslinking agent in a solvent. Though water is usually used as the solvent, aqueous mixed solvents containing an organic solvent having compatibility with water may also be used. Besides these solvents, organic solvents can be used. Any organic solvents that can dissolve the crosslinking agent therein can be used. Examples of organic solvents include alcohols such as methanol, ethanol, isopropanol, and glycerin; ketones such as acetone and methyl ethyl ketone; esters such as methyl acetate and ethyl acetate; aromatic solvents such as toluene; ethers such as tetrahydrofuran; and halogenated hydrocarbon based solvents such as dichloromethane.

The resin-containing particles that are used in the invention may contain fine particles other than the foregoing resins depending upon the purpose. According to such resin-containing particles, in the case where the resin powder as an agglomerate of the resin-containing particles is compounded in a cosmetic, not only an effect for preventing re-coagulation of the resin-containing particles is excellent, but also functions caused by the fine particles can be revealed while keeping usability of the cosmetic based on characteristics possessed by the resin of the resin-containing particles as compared with the case where the resin-containing particles and the fine particles are separately compounded in a cosmetic.

It is preferable that the fine particles are adhered onto the resin surface. In the case where the fine particles are adhered on the resin surface, the foregoing effect for preventing re-coagulation of the resin-containing particles, etc. can be remarkably revealed as compared with the case where the fine particles are contained inside the resin. The average volume particle size of the fine particles relies upon their compounding amount in a cosmetic and the average volume particle size of the resin-containing particles but is preferably not more than 3 μm. When the average volume particle size of the fine particles exceeds 3 μm, in the case where the fine particles are adhered onto the resin surface, their adhesive strength is liable to decrease.

A particularly preferred combination of the rein-containing particles and the fine particles is a combination where a ratio of (average volume particle size of the resin-containing particles)/(average volume particle size of the fine particles) is 2 or more. The content of the fine particles in the resin-containing particles relies upon the particle size of the fine particles and the type of the cosmetic in which the fine particles are compounded but is usually from 0.1 to 20% by weight.

As the fine particles, ones that are usually compounded in a cosmetic, such as pigments, coloring matters, ultraviolet ray absorbers, ultraviolet ray screening agents, infrared ray absorbers, infrared ray shielding agents, and antibacterial agent, are used. When a pigment is used as the fine particles, uniform and durable coloring properties are obtained; when an ultraviolet ray screening agent is used, a uniform and durable anti-sunburn effect due to its ultraviolet ray screening function is obtained; and when an infrared shielding agent is used, a uniform and durable infrared ray shielding effect is obtained.

With respect to the pigment, there are no limitations so far as it is generally employable in a cosmetic. Examples include inorganic pigments such as iron oxide and aluminum silicate; organic pigments such as carbon black; and extender pigments such as talc. Examples of the ultraviolet ray screening agent include inorganic compounds such as titanium oxide and cerium oxide; and organic compounds such as benzophenone based compounds, benzotriazole based compounds, and salicylic acid salt based compounds. Examples of the infrared ray shielding agent include titanium oxide, zirconium oxide, silicone carbide, and compounds thereof.

With respect to the resin-containing particles to be used in the invention, the resin or the fine particle-containing resin may be subjected to silicone treatment, metallic soap treatment, fatty acid treatment, surfactant treatment, or treatment with an acid, an alkali or an inorganic salt, or a combination thereof.

[Production Process of Resin Powder]

The resin powder of the invention can be produced by producing resin-containing fine particles (production step of resin-containing fine particles), producing matrix particles (production step of matrix particles), and then reshaping the matrix particles (reshaping step).

The production step of resin-containing fine particles can be carried out by, for example, emulsion polymerization coagulation, suspension polymerization, or dispersion polymerization. Of these methods, emulsion polymerization coagulation is preferable.

In the case where the resin-containing fine particles are produced by emulsion polymerization coagulation, first of all, a dispersion is prepared by emulsion polymerization using a monomer of the resin to be contained in the resin-containing fine particles, a solvent for dissolving the monomer, and an ionic surfactant, and the dispersion is then mixed with a an ionic surfactant having an opposite polarity to the former ionic surfactant to cause heterogeneous coagulation, thereby forming resin-containing fine particles having the desired particle size.

The production process of matrix particles is carried out by heating the resin-containing fine particles resulting from the production step of resin-containing fine particles to the glass transition point of the resin or higher and holding them for a certain period of time (ensphering time) to fuse and unify the resin-containing fine particles, thereby obtained matrix particles. At this time, the ensphering time is preferably from 4 to 10 hours, and more preferably from 5 to 7 hours. When the ensphering time is shorter than 4 hours, SF1 becomes larges so that when compounded in a cosmetic, smoothness tends to become worse. On the other hand, when the ensphering time exceeds 10 hours, SF1 becomes close to 100 so that when compounded in a cosmetic, adhesiveness tends to become worse.

The reshaping step can be carried out by the following two methods.

One method is a method in which a heat and a mechanical shear force are applied to a dispersion of the matrix particles resulting from the production step of matrix particles. According to this method, it is possible to reshape the matrix particles in an arbitrary shape and make them have desired values of shape factor SF1, b/a and c/b.

Another method is a method in which a physical stress is applied to the matrix particles dispersed in the dispersion.

For the sake of applying a stress, the dispersion medium having the matrix particles dispersed therein is mixed and stirred with media such as glass beads, sand beads, zirconia beads, resin beads, and resin-coated ferrite beads preferably in the same volume as the amount of the dispersion.

In the case where such a medium is used, it is preferable that the bead diameter (D) is satisfied with the following relation against the average volume particle size (D₅₀) of the matrix particles.

100<D/D₅₀<2,000

In the case where the foregoing relation is not satisfied, i.e., in the case where D/D₅₀ is not more than 100, it is not possible to sufficiently apply a stress to the matrix particles, whereas in the case where D/D₅₀ is 2,000 or more, it is very difficult to uniformly apply a stress to the matrix particles so that the thickness of the resulting resin powder may possibly scatter to considerable extent. It is preferable from the standpoint of improvements in pulverization efficiency that the medium has a specific gravity of from 1.0 to 5.0. It is more preferable that the bead diameter (D) is satisfied with the following relation against the average volume particle size (D₅₀) of the matrix particles.

200<D/D₅₀<1,000

In this case, the pulverization can be effectively conducted.

Stirring and mixing may be carried out at a temperature at which the constitutional resin of the matrix particles is not finely pulverized, and preferably at a temperature in the vicinity of the glass transition point of the resin. By mixing and stirring at a temperature in the vicinity of the glass transition point using the foregoing medium, it is possible to deform the matrix particles in a flat shape without causing breakage of the matrix particles.

Specific examples of devices that are provided for mixing and stirring include a sand mill and an Eiger motor mill.

For the sake of applying a physical stress to the matrix particles, the matrix particles dispersed in the dispersion may be collided against a uniform plane under high pressure. As the uniform plane, a wall made of a metal, etc. and water surface can be enumerated. In this case, the pressure to be applied to the matrix particles is preferably from 20 to 200 MPa from the reason that the pulverized particle size is controlled to a proper value. The concentration of the matrix particles to be dispersed in the dispersion is preferably from 1 to 50% by weight from the reason that the pulverized particle size is controlled to a proper value. In the case where the shape of the matrix particles is more strictly controlled, it is preferable that the reshaping step is carried out at a temperature of the glass transition point of the resin or higher. A device that is used in the reshaping step is not particularly limited so far as it is provided with a general high-pressure injection unit and a smooth wall surface. Specifically, a nanomizer (manufactured by Yoshida Kikai Co., Ltd.) can be enumerated.

By controlling the temperature of the matrix particle solution after the reshaping step, it is possible to make the shape or surface smooth.

After the reshaping step, the resulting agglomerate of the resin-containing particles is rinsed and subjected to solid-liquid separation, followed by drying to obtain a resin powder. Though the solid-liquid separation to be carried out after rinsing is not particularly limited, suction filtration, pressure filtration, etc. are preferably employed from the standpoint of productivity. Further, though the drying is not particularly limited, freeze-dry lyophilization, flash jet drying, fluidized drying, vibration type fluidized drying, etc. are preferably employed from the standpoint of productivity.

A specific example of a series of steps of the production process of the resin powder will be described.

First of all, resin-containing fine particles having a number average particle size of from 10 to 500 nm are prepared in a dispersion medium by emulsion polymerization coagulation.

Next, the resin-containing fine particles are subjected to a salting-out step and a fusion step at the same time, to prepare secondary particles. Concretely, the salt-out step as referred to herein means a step in which the resin fine particles are subjected to salting-out with a coagulant to remove the excessive dispersant and surfactant, etc., and the fusion step as referred to herein means a step in which the size of the resin particles is regulated by heating and fusion. The salting-out step and the fusion step can be carried out in an agitation mechanism-provided reaction device having an agitating element.

And the secondary particles are subjected to reshaping treatment of matrix partiecles in a reshaping step as matrix particles. Concretely, a step of circulating the matrix particles into a heated and pressurized bottle neck is carried out in two stages. Examples of a device that is specifically used in the second stage of the two stages include an annular type stirring mill and a Goulin.

Thus, the matrix particles are flattened, and an agglomerate of the resin-containing particles is obtained. Thereafter, the dispersion containing an agglomerate of the resin-containing particles is filtered and rinsed to remove the dispersion stabilizer, etc., followed by drying. There is thus obtained the resin powder of the invention.

In the case where the resin-containing particles containing the resin and the fine particles is produced, it is required to contain fine particles in the resin-containing particles. As the method of containing fine particles in the resin-containing particles, there are employed a method of adhering fine particles onto the resin surface, a method of containing fine particles inside the resin, and a method of externally adding fine particles onto the resin surface.

In the method of adhering fine particles onto the resin surface, for example, coagulated particles as a matrix in the coagulation step of the emulsion polymerization coagulation are obtained, and in the next stage, a dispersion of the foregoing fine particles (for example, functional fine particles) is mixed with a liquid containing the coagulated particles to prepare a mixed liquid. And the functional fine particles are adhered onto the surfaces of the coagulated particles as the matrix and then fused and unified upon heating to form an encapsulated structure by fine particles (a structure in which the resin surface is covered by the functional fine particles). Thus, the fine particles can be deposited on the resin surface. In the case where the resin has a polar group, by subjecting fine particles such as metallic ultrafine particles to ion exchange in the state of ion or coordination to reduce the resin, it is possible to adhere the metallic ultrafine particles onto the resin surface.

In the method of producing resin-containing particles containing fine particles inside the resin, when coagulated particles as a matrix in the coagulation step of emulsion polymerization coagulation are obtained, there is employed a method in which the fine particles are dispersed together with the monomer in the dispersion. Thus, it is possible to produce resin-containing particles having a capsule structure containing fine particles therein.

As the method of externally adding fine particles onto the resin surface, there are employed a method in which after drying resin-containing particles, the resin-containing particles and fine particles are adhered onto the surface in a dry mode using a mixing machine such as a V blender and a Henschel mixer; a method in which after dispersing fine particles in a liquid (for example, water) the resin is added to a slurry obtained by dispersion, followed by drying to adhere the fine particles onto the resin surface; and a method of drying while spraying the foregoing slurry onto the dried resin powder.

[Cosmetic]

Next, an embodiment of the cosmetic of the invention will be described.

The cosmetic of the invention can be applied to any cosmetics so far as they contain the foregoing resin powder.

By containing the foregoing resin powder, the cosmetic of the invention reveals sufficient spreadability upon application to the skin and enables one to obtain further proper affinity and further wet touch after application as compared with cosmetics containing a resin powder that falls outside the scope as defined in this application with respect to the degree of hydrophobicity and the particle shape as expressed by a, b and c. Especially, in the case where the cosmetic is in the solid state or lotion state, sufficient dry touch is obtained after application as compared with cosmetics containing a resin powder that falls outside the scope as defined in this application with respect to the degree of hydrophobicity and the particle shape as expressed by a, b and c.

Examples of such cosmetics include makeup-cosmetics such as foundation, face powder, face paint, lipstick, powder lip, lip gloss, cheek rouge, eye shadow, eye liner, eye brow, mascara, and dusting powder, baby powder, shaving lotion, shaving cream, calamine lotion, cleansing cream, cleansing powder, emulsion, cream, ointment, peel-off pack, antiperspirant, deodorant, hair dye, hair setting lotion, hair tonic, hair growth lotion, and baldness remedy.

The form of the cosmetic may be any form such as liquid, paste, O/W emulsion, W/O emulsion, gel, powder, and solid.

The cosmetic of the invention can contain a blend selected from the following group of blends as usage of cosmetics.

Examples of blends include masking agents (such as water and perfumes), general-purpose oils, volatile oils (such as diorganosiloxane oligomers and lower alcohols), refrigerative (such as nonionic surfactants, anionic surfactants, cationic surfactants, ampholytic surfactants, menthol, and camphor), antiphlogistic agents (such as dipotassium glycyrrhetinate, allantoin, and guaiazulene), thickening agents (such as poly(sodium acrylate), polyvinyl alcohol, methyl cellulose, bentonite, and hectorite), antiseptics (such as methylparaben, butylparaben, and propylparaben), dispersants, antioxidants, silicones, metallic chelating agents, emulsifiers, pH adjustors, pigments, colorants, coloring matters, coating agents, converging agents, humectants, various medicines, components for beauty, antiperspirants, ultraviolet ray absorbers, ultraviolet screening agents, bactericides, germicides, perfumes, and other substances.

Examples of other substances include talc, sericite, mica, otorido-silica, kaolin, zinc white, magnesium carbonate, calcium carbonate, bentonite, hectorite, aluminum silicate, barium silicate, calcium silicate, magnesium silicate, magnesium, silica, zeolite, barium sulfate, calcium phosphate, silk powder, polyethylene resin powder, polytetrafluoroethylene powder, acrylic resin powder, polypropylene resin powder, polystyrene resin powder, vinyl chloride resin powder, cellulose powder, nylon resin powder, silicone resin powder, and polyorganosilsesquioxane powder. These substances can be used singly or in admixture of two or more thereof. These substances may be subjected to silicone treatment, metallic soap treatment, fatty acid treatment, surfactant treatment, or treatment with an acid, an alkali or an inorganic salt, or a combination thereof.

The pigment is not particularly limited so far as it is useful for cosmetics, and white pigments or colored pigments can be used. Examples of white pigments include titanium oxide and zinc oxide. Examples of colored pigments include iron oxide, iron titanate, iron oxide yellow, ultramarine, Prussian blue, chromium oxide, carbon black, low order titanium oxide, aluminum powder, copper powder, titanated mica, bismuth oxychloride, pearlescent pigments such as fish scale guanine, organic pigments (such as Red No. 3, Red No. 104, Red No. 106, Red No. 201, Red No. 202, Red No. 204, Red No. 205, Red No. 220, Red No. 226, Red No. 227, Red No. 228, Red No. 230, Red No. 405, Red No. 505, Orange No. 204, Orange No. 205, Yellow No. 4, Yellow No. 5, Yellow No. 202, Yellow No. 203, Yellow No. 205, Yellow No. 401, and Blue No. 404), chlorophyll, and β-carotene. These pigments can be used singly or in admixture of two or more thereof. Further, these pigments maybe subjected to silicone treatment, metallic soap treatment, fatty acid treatment, surfactant treatment, or treatment with an acid, an alkali or an inorganic salt, or a combination thereof.

The oil is compounded for the purposes of imparting good adhesiveness to the skin and obtaining wet touch on the skin. The oil is not particularly limited so far as it is employed in usual cosmetics, and examples include oils and fats, waxes, hydrocarbons, synthetic esters, fatty acids, and higher alcohols. Specific examples of oil components include oils and fats (such as camellia oil, olive oil, jojoba oil, castor oil, and mink oil), waxes (such as carnauba wax, bee wax, lanolin, and candelilla wax), hydrocarbons (such as squalane, Vaseline, liquid paraffin, paraffin wax, and microcrystalline wax), fattyacids (such as stearic acidandoleic acid), higher alcohols (such as cetanol, stearyl alcohol, oleyl alcohol, and behenyl alcohol), esters (such as cetyl isooctanate, isopropyl myristate, and glyceryl trioctanate), lanolin derivatives, silicones, and fluorine based oils. These oil components can be used singly or in admixture of two or more thereof. These oil components may be used in combination with volatile oils such as diorganosiloxane oligomers and lower alcohols. The cosmetic of the invention is especially effective in the case where it is compounded with fatty acids, higher alcohols, or esters as the oil component. In this case, there are observed marked differences in spreadability of the cosmetic upon application and affinity after application between the case of using the resin powder of the invention and the case of using a resin powder falling outside the scope of the invention. These differences are especially remarkable in the case where a resin powder containing a styrene-acrylate copolymer is used as the resin powder of the invention.

With respect to the cosmetic of the invention, its production process is not particularly limited, but general production processes of cosmetics are employable.

For example, a general production process of powdered cosmetics is as follows. That is, first of all, a pulverized powdered raw material containing the resin powder, extender pigment, colored pigment, etc. are stirred in a ribbon blender, a powder mixer, a Henschel mixer, a ball mill, a sand mill, a dyno mill, etc. to obtain a pigment mixture. Next, an oil component is melted and added to and uniformly mixed with the pigment mixture. At this time, the powdered raw material may be pulverized after mixing with the oil component.

Subsequently, the resulting mixture is taken out and passed through a sieve to adjust the grain size, and then filled in a container such as a metallic dish. There is thus obtained a powdered cosmetic.

Emulsified cosmetics can be produced by a usually employed process. In this production process, first of all, a water phase portion having a hydrophilic component (such as a humectant) added to purified water and an oil phase portion having an oleophilic component added to an oil are prepared. The water phase portion and the oil phase portion are prepared in a separate container from each other. Next, the water phase portion and the oil phase portion are respectively heated to 60° C. or higher, and the both are gradually mixed to conduct emulsification. After completion of the emulsification, the mixture is cooled and then filled in a container. There is thus obtained an emulsified cosmetic.

In the production process of emulsified cosmetics, an emulsion prepared by mixing the oil phase and the water phase may be of a water-in-oil type (W/O type) or an oil-in-water type (O/W type).

In the case where the cosmetic is an antiperspirant composition, its production process is not particularly limited, and the antiperspirant composition can be produced by a known process. For example, in the case of producing an emulsified antiperspirant composition, in general, a hydrophilic component is first added to purified water to form a water phase portion, and an oleophilic component is added to an oil component to form an oil phase portion. The both are gradually mixed to conduct emulsification. At this time, the resin contained in the resin-containing particles is contained in the oil phase portion. After completion of the emulsification, the mixture is cooled and then filled in a container. There is thus obtained an antiperspirant composition.

### EXAMPLES

Next, the invention will be specifically described below in detail with reference to the following Examples and Comparative Examples, but it should not be construed that the invention is limited thereto.

### PREPARATION EXAMPLE 1

First of all, a solution obtained by mixing and dissolving styrene, n-butyl acrylate, acrylic acid, and dodecanethiol (hereinafter referred to as “DDT”) in compounding amounts shown in Table 2 was dispersed and emulsified in a solution of 13 g of an anionic surfactant, Neogen R (sodium dodecylbenzenesulfonate manufactured by Dai-ichi Kogyo Seiyaku Co., Ltd.) in 555 g of ion-exchange water in a flask. While gradually mixing the emulsion for 10 minutes, 42.8 g of ion-exchange water having 9 g of ammonium persulfate dissolved therein was charged in the flask, followed by purging with nitrogen. Thereafter, the flask was heated while stirring over an oil bath until the contents reached 70° C. Emulsion polymerization was continued as it was for 6 hours, to obtain a dispersion 1.

TABLE 2

| Formulation | Dispersion |
|---|---|
| Styrene (g) | 540 |
| n-Butyl acrylate (g) | 60 |
| Acrylic acid (g) | 12 |
| DDT (g) | 12 |

Next, a resin powder was prepared in the following manner using the dispersion 1.

That is, 520 g of the dispersion, 4.2 g of a 10% by weight aqueous solution of poly(aluminum chloride) (PAC100W manufactured by Asada Chemical Co., Ltd.), and 38 g of 0.02M nitric acid were charged in a round-bottom stainless steel flask, followed by thoroughly mixing and dispersing in a homogenizer (Ultra Turrax T50 manufactured by IKA Works Inc.). Thereafter, the flask was heated to 60° C. while stirring over an oil bath for heating. After keeping at 60° C. for 30 minutes, 200 g of the dispersion was added in proportions, and the temperature of the oil bath for heating was raised to 90° C., at which the mixture was maintained for 9 hours to obtain coagulated particles (resin-containing fine particles).

Thereafter, 52 g of 1N sodium hydroxide was added to the flask, and the stainless steel flask was hermetically sealed. While continuing stirring using a magnetic seal, the mixture was heated to 96° C., and the coagulated particles were fused while maintaining the mixture for 7 hours (ensphering time), to obtain fused particles (matrix particles). The average volume particle size (D₅₀) of the fused particles was measured using a Coulter counter (TAII manufactured by Nikkaki Bios Co., Ltd.).

Next, glass beads having a diameter of 1 mm were added to the dispersion having the fused particles dispersed therein (fused particle dispersion) and stirred and mixed at a stirring rate of 3,000 rpm for 20 hours, thereby subjecting the fused particles to reshaping treatment. At this time, the stirring and mixing were carried out at a liquid temperature of 55° C. Thereafter, the fused particles having been subjected to reshaping treatment were thoroughly rinsed with ion-exchange water having a pH of 6.5 and then subjected to vacuum lyophilization to obtain a resin powder.

With respect to the thus obtained resin powder, the degree of hydrophobicity, shape factor SF1, b/a, c/b, average volume particle size, glass transition temperature, and surfaceness index were measured. The results are shown in Table 3.

By measuring the methanol concentration 1 and the methanol concentration 2, the degree of hydrophobicity of the resin powder was calculated based on the following equation:

[Degree of hydrophobicity (%)]=[(methanol concentration 1(%))+(methanol concentration 2(%))]/2

Here, the methanol concentration 1 and the methanol concentration 2 were determined in the following manner. That is, first of all, a plural number of beakers were prepared. Sixty mL of plural methanol aqueous solutions having a different concentration from each other by 10% from 0 to 100% were respectively charged in each of these beakers. Then, 0.1 g of the resin powder was added to each aqueous solution, the mixture was lightly stirred by a magnet stirrer, and the aqueous solution in the beaker was observed. From the observation results, the methanol concentration 1 and methanol concentration 2 were determined.

The shape factor SF1 was measured using a LUZEX image analyzer (LUZEX III manufactured by Nireco Corporation).

b/a and c/b were measured by image analysis using FE-SEM (Model S-2700 manufactured by Hitachi, Ltd.). At this time, in measuring a and b, a sample stage table of the FE-SEM was rotated in various directions, thereby seeking and measuring the direction where the projected area became maximum. In measuring c, the measurement was carried out while rotating the sample stage around the major axis as an axis.

The average volume particle size (D₅₀) was measured using a laser diffraction type particle size distribution analyzer (LA-700 manufactured by Horiba, Ltd.).

The surfaceness index was calculated according to the following equations:

(Surfaceness index)=(specific surface area measured)/(specific surface area calculated)

(Specific surface area calculated)=6Σ(n×R²)/{ρ×Σ(n×R³)}

(wherein n represents the number of particles within a channel of a Coulter counter (TAII manufactured by Nikkaki Bios Co., Ltd.); R represents a diameter (μm) of the channel of the Coulter counter; and ρ represents a density of the agglomerate of the resin-containing particles).

TABLE 3

| | Preparation | Preparation | Preparation | Preparation | Preparation | Preparation |
|---|---|---|---|---|---|---|
| | Example 1 | Example 2 | Example 3 | Example 4 | Example 5 | Example 6 |
| Degree of | 30 | 30 | 30 | 35 | 15 | 45 |
| hydrophobicity | | | | | | |
| Methanol | 20 | 20 | 20 | 20 | 10 | 40 |
| concentration 1 (%) | | | | | | |
| Methanol | 40 | 40 | 40 | 50 | 20 | 50 |
| concentration 2 (%) | | | | | | |
| Shape factor SF1 | 126 | 137 | 111 | 131 | 122 | 147 |
| b/a | 0.7 | 0.8 | 1.0 | 0.9 | 1.0 | 0.5 |
| c/b | 0.6 | 0.7 | 1.0 | 0.9 | 1.0 | 0.2 |
| Average volume | 6.6 | 7.3 | 6.3 | 6.2 | 6.9 | 8.5 |
| particle size (μm) | | | | | | |
| Tg (° C.) | 60 | 60 | 60 | 60 | 166 | 53 |
| Surfaceness index | 1.52 | 1.66 | 1.34 | 1.30 | 1.21 | 2.33 |

### PREPARATION EXAMPLE 2

The fused particle dispersion obtained in Preparation Example 1 was filtered, and the fused particles were thoroughly rinsed with ion-exchange water having a pH of 6.5 and then subjected to vacuum lyophilization to obtain resin particles. Thirty parts by weight of the resulting resin particles and 1 part by weight (based on 30 parts by weight of the resin particles)- of an anionic surfactant, Neogen R (manufactured by Dai-ichi Kogyo Seiyaku Co., Ltd.) were dispersed in water and collided against a stainless steel smooth wall surface at 160 MPa, thereby conducting reshaping treatment of the resin particles. At this time, the liquid temperature was set up at 150° C. This operation was carried out using a nanomizer (manufactured by Yoshida Kikai Co., Ltd.).

And the fused particles having been subjected to reshaping treatment were subjected to vacuum lyophilization to obtain a resin powder.

With respect to the thus obtained resin powder, the degree of hydrophobicity, shape factor SF1, b/a, c/b, average volume particle size, glass transition temperature, and surfaceness index were measured in the same manners as in Preparation Example 1. The results are shown in Table 3.

### PREPARATION EXAMPLE 3

The fused particle dispersion obtained in Preparation Example 1 was filtered, and the fused particles were thoroughly rinsed with ion-exchange water having a pH of 6.5 and then subjected to vacuum lyophilization to obtain a resin powder.

With respect to the thus obtained resin powder, the degree of hydrophobicity, shape factor SF1, b/a, c/b, average volume particle size, glass transition temperature, and surfaceness index were measured in the same manners as in Preparation Example 1. The results are shown in Table 3.

### PREPARATION EXAMPLE 4

A resin powder was obtained in the same method as in Preparation Example 3, except for changing the holding time over the oil bath for heating after addition of the dispersion 1 to 4 hours.

With respect to the thus obtained resin powder, the degree of hydrophobicity, shape factor SF1, b/a, c/b, average volume particle size, glass transition temperature, and surfaceness index were measured in the same manners as in Preparation Example 1. The results are shown in Table 3.

### PREPARATION EXAMPLE 5

A commercially available spherical nylon resin was used as the resin powder, which was provided for Preparation Example 5. And with respect to this spherical nylon resin, the degree of hydrophobicity, shape factor SF1, b/a, c/b, average volume particle size, glass transition temperature, and surfaceness index were measured in the same manners as in Preparation Example 1. The results are shown in Table 3.

### PREPARATION EXAMPLE 6

A commercially available styrene-acrylate resin was used as the resin powder, melted and then pulverized using a pulverizer (AFG400 manufactured by Nippon Pneumatic Mfg. Co., Ltd.), which was provided for Preparation Example 6.

And with respect to this styrene-acrylate resin, the degree of hydrophobicity, shape factor SF1, b/a, c/b, average volume particle size, glass transition temperature, and surfaceness index were measured in the same manners as in Preparation Example 1. The results are shown in Table 3.

### Example 1

Using the resin power prepared in Preparation Example 1, a solid powdered foundation was prepared according to the following preparation.

That is, first of all, the components (1) to (7) shown in the following Table 4 were mixed in a Nauta mixer manufactured by Hosokawa Micron Corporation, to which was then added a mixture having the components (8) to (11) shown in Table 4 heated and melted therein, followed by uniformly mixing. The mixture was passed through a sieve and filled in a metallic dish to obtain a solid powdered foundation.

The thus obtained foundation was applied to the skins of 20 males and females constituting a panel, and spreadability upon application, affinity after application, clearness of the cosmetic layer, and durability of clearness were subjected to organoleptic test. The results are shown in Table 4.

As the affinity after application, affinity immediately after application of the cosmetic was employed, and as the durability of clearness, appearance of the cosmetic five hours after application was observed and judged. The spreadability upon application, affinity after application, clearness of the cosmetic layer, and durability of clearness were evaluated according to the following criteria. The numerical values in Table 4 are an average value of the evaluation by the 20 panelists.

Very good: 5

Good: 4

Moderate: 3

Bad: 2

Very bad: 1

TABLE 4

| | | | Comparative | Comparative | Comparative | Comparative | Comparative |
|---|---|---|---|---|---|---|---|
| | Example 1 | Example 2 | Example 1 | Example 2 | Example 3 | Example 4 | Example 5 |
| (1) Talc | 18 | 18 | 18 | 18 | 18 | 18 | 18 |
| (2) Mica | 0.2 | 0.2 | 0.2 | 0.2 | 0.2 | 0.2 | 0.2 |
| (3) Titanium | 10 | 10 | 10 | 10 | 10 | 10 | 10 |
| oxide | | | | | | | |
| (4) Iron oxide red | 0.8 | 0.8 | 0.8 | 0.8 | 0.8 | 0.8 | 0.8 |
| (5) Iron oxide | 1.8 | 1.8 | 1.8 | 1.8 | 1.8 | 1.8 | 1.8 |
| yellow | | | | | | | |
| (6) Iron oxide | 0.4 | 0.4 | 0.4 | 0.4 | 0.4 | 0.4 | 0.4 |
| black | | | | | | | |
| (7) Preparation | 22 | — | — | — | — | — | — |
| Example 1 | | | | | | | |
| (7) Preparation | — | 22 | — | — | — | — | — |
| Example 2 | | | | | | | |
| (7) Preparation | — | — | 22 | — | — | — | — |
| Example 3 | | | | | | | |
| (7) Preparation | — | — | — | 22 | — | — | — |
| Example 4 | | | | | | | |
| (7) Preparation | — | — | — | — | 22 | — | — |
| Example 5 | | | | | | | |
| (7) Preparation | — | — | — | — | — | 22 | — |
| Example 6 | | | | | | | |
| (8) Squalane | 5 | 5 | 5 | 5 | 5 | 5 | 5 |
| (9) Liquid | 3 | 3 | 3 | 3 | 3 | 3 | 3 |
| paraffin | | | | | | | |
| (10) Vaseline | 2 | 2 | 2 | 2 | 2 | 2 | 2 |
| (11) Antiseptic | 0.1 | 0.1 | 0.1 | 0.1 | 0.1 | 0.1 | 0.1 |
| Spreadability | 4.6 | 4.5 | 4.9 | 3.1 | 4.2 | 2.2 | 1.8 |
| upon application | | | | | | | |
| Affinity after | 4.5 | 4.3 | 1.5 | 1.2 | 1.6 | 1.1 | 1.3 |
| application | | | | | | | |
| Clearness of | 4.7 | 4.8 | 3.2 | 3.3 | 3.0 | 2.6 | 1.5 |
| cosmetic layer | | | | | | | |
| Durability of | 4.8 | 4.9 | 3.7 | 3.9 | 3.4 | 2.2 | 2.0 |
| clearness | | | | | | | |

### Example 2 and Comparative Examples 1 to 5

Solid powdered foundations were prepared in the same manner as in Example 1, except that each of the resin powders according to Preparation Examples 2 to 6 was used in place of the resin powder according to Preparation Example 1, or the resin powder was not used. With respect to the thus obtained solid powdered foundations, spreadability upon application, affinity after application, clearness of the cosmetic layer, and durability of clearness were subjected to organoleptic test in the same manners as in Example 1. The results are shown in Table 4.

### Examples 3 and 4 and Comparative Examples 6 to 10

Solid powdered eye shadows were prepared in the following manner by using each of the resin powders of Preparation Examples 1 to 6 or not using the resin powder.

That is, first of all, the components (1) to (5) shown in the following Table 5 were mixed, to which was then added a mixture having the components (6) to (9) shown in Table 5 heated and melted therein, followed by uniformly mixing and pulverization. The mixture was passed through a sieve and filled in a container to obtain a solid powdered eye shadow. The thus obtained solid powdered eye shadows were subjected to organoleptic test in the same manners as in Example 1. The results are shown in Table 5.

TABLE 5

| | | | Comparative | Comparative | Comparative | Comparative | Comparative |
|---|---|---|---|---|---|---|---|
| | Example 3 | Example 4 | Example 6 | Example 7 | Example 8 | Example 9 | Example 10 |
| (1) Talc | 14 | 14 | 14 | 14 | 14 | 14 | 14 |
| (2) Mica | 20 | 20 | 20 | 20 | 20 | 20 | 20 |
| (3) Titanium | 10 | 10 | 10 | 10 | 10 | 10 | 10 |
| oxide | | | | | | | |
| (4) Ultramarine | 7 | 7 | 7 | 7 | 7 | 7 | 7 |
| (5) Preparation | 15 | — | — | — | — | — | — |
| Example 1 | | | | | | | |
| (5) Preparation | — | 15 | — | — | — | — | — |
| Example 2 | | | | | | | |
| (5) Preparation | — | — | 15 | — | — | — | — |
| Example 3 | | | | | | | |
| (5) Preparation | — | — | — | 15 | — | — | — |
| Example 4 | | | | | | | |
| (5) Preparation | — | — | — | — | 15 | — | — |
| Example 5 | | | | | | | |
| (5) Preparation | — | — | — | — | — | 15 | — |
| Example 6 | | | | | | | |
| (6) Squalane | 5 | 5 | 5 | 5 | 5 | 5 | 5 |
| (7) Glycerin | 3 | 3 | 3 | 3 | 3 | 3 | 3 |
| (8) Monooleic | 1 | 1 | 1 | 1 | 1 | 1 | 1 |
| acid polyoxyethylene | | | | | | | |
| sorbitan | | | | | | | |
| (9) Antiseptic | 1 | 1 | 1 | 1 | 1 | 1 | 1 |
| Spreadability | 4.3 | 4.0 | 4.5 | 3.0 | 4.2 | 1.9 | 1.6 |
| upon application | | | | | | | |
| Affinity after | 4.5 | 4.2 | 1.5 | 1.2 | 1.5 | 1.1 | 1.2 |
| application | | | | | | | |
| Clearness of | 4.8 | 4.8 | 4.0 | 4.0 | 3.9 | 2.4 | 2.2 |
| cosmetic layer | | | | | | | |
| Durability of | 4.6 | 4.5 | 3.8 | 4.0 | 3.5 | 3.0 | 3.8 |
| clearness | | | | | | | |

### Examples 5 and 6 and Comparative Examples 11 to 15

Face paints were prepared in the following manner by using each of the resin powders of Preparation Examples 1 to 6 or not using the resin powder.

That is, first of all, the components (1) to (6) shown in the following Table 6 were mixed, to which was then added a mixture having the components (7) to (9) shown in Table 6 heated and melted therein, followed by uniformly mixing. The mixture was passed through a sieve and filled in a container to obtain a face paint. The thus obtained face paints were subjected to organoleptic test in the same manners as in Example 1. The results are shown in Table 6.

TABLE 6

| | | | Comparative | Comparative | Comparative | Comparative | Comparative |
|---|---|---|---|---|---|---|---|
| | Example 5 | Example 6 | Example 11 | Example 12 | Example 13 | Example 14 | Example 15 |
| (1) Talc | 25 | 25 | 25 | 25 | 25 | 25 | 25 |
| (2) Mica | 2 | 2 | 2 | 2 | 2 | 2 | 2 |
| (3) Titanium | 10 | 10 | 10 | 10 | 10 | 10 | 10 |
| oxide | | | | | | | |
| (4) Zinc oxide | 5 | 5 | 5 | 5 | 5 | 5 | 5 |
| (5) Iron oxide red | 0.5 | 0.5 | 0.5 | 0.5 | 0.5 | 0.5 | 0.5 |
| (6) Preparation | 22 | — | — | — | — | — | — |
| Example 1 | | | | | | | |
| (6) Preparation | — | 22 | — | — | — | — | — |
| Example 2 | | | | | | | |
| (6) Preparation | — | — | 22 | — | — | — | — |
| Example 3 | | | | | | | |
| (6) Preparation | — | — | — | 22 | — | — | — |
| Example 4 | | | | | | | |
| (6) Preparation | — | — | — | — | 22 | — | — |
| Example 5 | | | | | | | |
| (6) Preparation | — | — | — | — | — | 22 | — |
| Example 6 | | | | | | | |
| (7) Squalane | 1.5 | 1.5 | 1.5 | 1.5 | 1.5 | 1.5 | 1.5 |
| (8) Liquid | 3 | 3 | 3 | 3 | 3 | 3 | 3 |
| paraffin | | | | | | | |
| (9) Antiseptic | 2 | 2 | 2 | 2 | 2 | 2 | 2 |
| Spreadability | 4.6 | 4.5 | 4.9 | 4.0 | 4.6 | 2.2 | 2.3 |
| upon application | | | | | | | |
| Affinity after | 4.5 | 4.2 | 1.8 | 1.4 | 1.5 | 1.1 | 1.2 |
| application | | | | | | | |
| Clearness of | 4.7 | 4.9 | 3.8 | 3.9 | 3.4 | 3.8 | 1.6 |
| cosmetic layer | | | | | | | |
| Durability of | 4.8 | 4.9 | 3.0 | 3.1 | 2.6 | 2.8 | 1.3 |
| clearness | | | | | | | |

### Examples 7 and 8 and Comparative Examples 16 to 20

Cheek rouges were prepared in the following manner by using each of the resin powders of Preparation Examples 1 to 6 or not using the resin powder.

That is, first of all, the components (1) to (6) shown in the following Table 7 were mixed, to which was then added a mixture having the components (7) to (9) shown in Table 7 heated and melted therein, followed by uniformly mixing. The mixture was passed through a sieve and filled in a container to obtain a cheek rouge. The thus obtained cheek rouges were subjected to organoleptic test in the same manners as in Example 1. The results are shown in Table 7.

TABLE 7

| | | | Comparative | Comparative | Comparative | Comparative | Comparative |
|---|---|---|---|---|---|---|---|
| | Example 7 | Example 8 | Example 16 | Example 17 | Example 18 | Example 19 | Example 20 |
| (1) Talc | 25 | 25 | 25 | 25 | 25 | 25 | 25 |
| (2) Mica | 3 | 3 | 3 | 3 | 3 | 3 | 3 |
| (3) Titanium | 3 | 3 | 3 | 3 | 3 | 3 | 3 |
| oxide | | | | | | | |
| (4) Titanated | 3 | 3 | 3 | 3 | 3 | 3 | 3 |
| mica | | | | | | | |
| (4) Iron oxide red | 1 | 1 | 1 | 1 | 1 | 1 | 1 |
| (5) Red pigment | 1.5 | 1.5 | 1.5 | 1.5 | 1.5 | 1.5 | 1.5 |
| (6) Preparation | 22 | — | — | — | — | — | — |
| Example 1 | | | | | | | |
| (6) Preparation | — | 22 | — | — | — | — | — |
| Example 2 | | | | | | | |
| (6) Preparation | — | — | 22 | — | — | — | — |
| Example 3 | | | | | | | |
| (6) Preparation | — | — | — | 22 | — | — | — |
| Example 4 | | | | | | | |
| (6) Preparation | — | — | — | — | 22 | — | — |
| Example 5 | | | | | | | |
| (6) Preparation | — | — | — | — | — | 22 | — |
| Example 6 | | | | | | | |
| (7) Squalane | 1.5 | 1.5 | 1.5 | 1.5 | 1.5 | 1.5 | 1.5 |
| (8) Liquid | 3 | 3 | 3 | 3 | 3 | 3 | 3 |
| paraffin | | | | | | | |
| (9) Antiseptic | 1 | 1 | 1 | 1 | 1 | 1 | 1 |
| Spreadability | 4.3 | 4.2 | 4.4 | 4.0 | 4.2 | 2.7 | 2.5 |
| upon application | | | | | | | |
| Affinity after | 4.5 | 4.3 | 1.5 | 1.4 | 1.3 | 1.5 | 1.6 |
| application | | | | | | | |
| Clearness of | 4.7 | 4.8 | 4.1 | 4.1 | 3.8 | 3.0 | 2.6 |
| cosmetic layer | | | | | | | |
| Durability of | 4.2 | 4.3 | 4.0 | 4.0 | 3.8 | 3.3 | 3.1 |
| clearness | | | | | | | |

From the results of the organoleptic tests shown in Tables 3 to 7, it has been noted that the cosmetics according to Examples 1 to 8 are excellent in spreadability upon application and are better in affinity to the skin and impart wet touch after application, as compared with the cosmetics according to Comparative Examples 1 to 20.

It has been noted that the cosmetics of Examples 1 to 6 are excellent in clearness and are found to have an effect for enduring the clearness, whereas the cosmetics of Comparative Examples 1 to 20 are not sufficient in clearness and not sufficient in its durability.

As described previously, according to the resin powder for cosmetic of the invention, when compounded in a cosmetic and applied to the skin, it reveals sufficient spreadability as compared with the case where the degree of hydrophobicity, shape factor SF1, and b/a or c/b fall outside the foregoing ranges. And it is possible to impart more proper affinity after application as compared with the case where the degree of hydrophobicity, shape factor SF1, and b/a or c/b fall outside the foregoing ranges.

According to the cosmetic of the invention, it is possible to reveal sufficient spreadability upon application to the skin as compared with the case where the degree of hydrophobicity, shape factor SF1, and b/a or c/b fall outside the foregoing ranges. And it is possible to impart more proper affinity after application as compared with the case where the degree of hydrophobicity, shape factor SF1, and b/a or c/b fall outside the foregoing ranges.

What is claimed is:

1. A resin powder for a cosmetic comprising particles containing a resin, wherein the particles have a degree of hydrophobicity of from 10% to 60%, and when seen from a direction in which a projected area of the particle to a plane is maximum, the particles are satisfactory with the following equations:
0.5<b/a<1
0.4<c/b<0.8
where
a is a major axis of each particle;
b is a minor axis of each particle; and
c is a thickness of each particle.

2. The resin powder according to claim 1, wherein the particles have an average value of shape factors SF1 of from 110 to 140 and the shape factor SF1 is defined by
SF1=(ML²/A)×(π/4)×100
where ML represents a maximum length of the particles, and A represents a projected area of the particles.

3. The resin powder according to claim 1, wherein the particles have an average value of shape factors SF1 of from 110 to 130 and the shape factor SF1 is defined by
SF1=(ML²/A)×(π/4)×100
where ML represents a maximum length of the particles, and A represents a projected area of the resin-containing particles.

4. The resin powder according to claim 1, wherein the particles have an average value of shape factors SF1 of from 110 to 120 and the shape factor SF1 is defined by
SF1=(ML²/A)×(π/4)×100
where ML represents a maximum length of the particles, and A represents a projected area of the resin-containing particles.

5. The resin powder according to claim 1, wherein a, b and c are simultaneously satisfactory with the following equations:
0.65<b/a<0.85
0.33<c/b<0.67

6. The resin powder according to claim 1, wherein 2 μm<a<20μm, 1 m<b<10 μm, and 0.2 μm<c<8 μm.

7. The resin powder according to claim 1, wherein the particles have an average volume particle size of from 2 μm to 20 μm.

8. The resin powder according to claim 1, wherein the resin has a glass transition temperature Tg of from 10 to 100° C.

9. The resin powder according to claim 1, wherein the resin has a glass transition temperature Tg of from 30 to 80° C.

10. The resin powder according to claim 1, wherin the resin powder has a surfaceness index not larger than 2.0 and the surfaceness index is defined by
(Surfaceness index)=(specific surface area measured)/(specific surface area calculated)
(Specific surface area calculated)=6Σ(n×R²)/{ρ×Σ(n×R³}
where n represents number of particles within a channel of a particle size distribution measurement device; R represents a diameter of the channel of the particle size distribution measurement device; and ρ represents a density of the agglomerate of the resin-containing particles.

11. The resin powder according to claim 1, wherein the resin is a polymer of a monomer selected from a group consisting of styrene, derivatives of styrene, acrylic acid esters, methacrylic acid esters, ethylenically unsaturated acid monomers, vinylnitriles, vinyl ethers, vinyl ketones, and olefins.

12. The resin powder according to claim 1, wherein the resin is a styrene-acrylate copolymer.

13. The resin powder according to claim 1, wherein the resin has a number average molecular weight Mn of from 5,000 to 20,000.

14. The resin powder according to claim 1, wherein fine particles are adhered onto the surfaces of the particles.

15. A process for preparing a resin powder for cosmetic including particles containing a resin, comprising a step of producing the-particles by emulsion polymerization, wherein the particles have a degree of hydrophobicity of from 10% to 60%, and when seen from a direction in which a projected area of the particle to a plane is maximum, the particles are satisfactory with the following equations:
0.5<b/a<1
0.4<c/b<0.8
where
a is a major axis of each particle;
b is a minor axis of each particle; and
c is a thickness of each particle.

16. The process according to claim 15, further comprising a step of flattening the particles by mixing and stirring the particles and a medium.

17. The process according to claim 15, further comprising a step of flattening the particles by colliding the particles against a uniform plane under high pressure.

18. A powdered cosmetic comprising an oil component and a resin powder including particles containing a resin, wherein the particles have a degree of hydrophobicity of from 10% to 60%, and when seen from a direction in which a projected area of the particle to a plane is maximum, the particles are satisfactory with the following equations:
0.5<b/a<1
0.4<c/b<0.8
where
a is a major axis of each particle;
b is a minor axis of each particle; and
c is a thickness of each particle.

19. A emulsified cosmetic comprising an oil component and a resin powder including particles containing a resin, wherein the particles have a degree of hydrophobicity of from 10% to 60%, and when seen from a direction in which a projected area of the particle to a plane is maximum, the particles are satisfactory with the following equations:
0.5<b/a<1
0.4<c/b<0.8
where
a is a major axis of each particle;
b is a minor axis of each particle; and
c is a thickness of each particle.

20. A antiperspirant cosmetic comprising an oil component and a resin powder including particles containing a resin, wherein the particles have a degree of hydrophobicity of from 10% to 60%, andwhen seen froma direction in which a projected area of the particle to a plane is maximums the particles are satisfactory with the following equations:
0.5<b/a<1
0.4<c/b<0.8
where
a is a major axis of each particle;
b is a minor axis of each particle; and
c is a thickness of each particle.
